(19) United States
(12) Patent Application Publication
(10) Pub. No.: US 2018/0091981 A1
(43) Pub. Date: Mar. 29, 2018

(54) SMART VEHICULAR HYBRID NETWORK SYSTEMS AND APPLICATIONS OF SAME

(71) Applicant: BOARD OF TRUSTEES OF THE UNIVERSITY OF ARKANSAS, Little Rock, AR (US)

(72) Inventors: Sachin SHARMA, LITTLE ROCK, AR (US); Muhammad AWAN, LITTLE ROCK, AR (US); Seshadri MOHAN, LITTLE ROCK, AR (US)

(21) Appl. No.: 15/705,542

(22) Filed: Sep. 15, 2017

Related U.S. Application Data
(60) Provisional application No. 62/398,811, filed on Sep. 23, 2016.

(51) Int. Cl. H04W 16/14; H04W 72/12; G06N 3/08

(52) U.S. Cl. CPC H04W 16/14; H04W 84/18; G06N 3/08; H04W 72/1226

(57) ABSTRACT

A vehicular hybrid network system includes a cognitive radio network service provider (CRNSP) module configured to host a cognitive radio ad hoc vehicular network (CRAVENET) and to provide information services to a plurality of vehicles in the CRAVENET. The system also includes a spectrum leasing module in communication with the network service provider module, the spectrum leasing module configured to communicate with a wireless service provider (WSP) to lease spectrum from the WSP for use by the plurality of vehicles in the CRAVENET.

### CROSS-REFERENCE TO RELATED APPLICATION

This application claims priority to and the benefit of U.S. Provisional Application No. 62/398,811, filed Sep. 23, 2016, which is herein incorporated by reference in its entirety.

### FIELD

The present disclosure relates generally to networking systems, more particularly to smart vehicular hybrid network systems and methods, e.g., for traffic management systems, driver assistant, Internet of Vehicles (IoV), Internet of Things (IoT) applications, local business marketing, traveler safety, and vehicular emission control.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In recent years, the demand for spectrum has increased exponentially. Cognitive radio (CR) technology provides the capability to dynamically sense the spectrum for available channels, either licensed or unlicensed, estimate them and select a good channel. CR technology facilitates a set of users (called secondary users) to utilize the available channels when the channels are not utilized by another set of users (called the primary users), who subscribe to the services offered by a service provider. Thus, CR allows for spectrum sharing in an opportunistic way and establishes a network of CR devices for transmitting and receiving information efficiently and improving spectrum and network utilization.

Therefore, an unaddressed need exists in the art to address the aforementioned deficiencies and inadequacies. This invention seeks to exploit the CR technology to build an adhoc vehicular network, which is an Internet of Vehicles (IoV), to serve as an enabling platform and to build innovative applications.

### SUMMARY

In accordance with at least one aspect of this disclosure, a vehicular hybrid network system includes a cognitive radio network service provider (CRNSP) module configured to host a cognitive radio ad hoc vehicular network (CRAVENET) and to provide information services to a plurality of vehicles in the CRAVENET. The system also includes a spectrum leasing module in communication with the network service provider module, the spectrum leasing module configured to communicate with a wireless service provider (WSP) to lease spectrum from the WSP for use by the plurality of vehicles in the CRAVENET.

The system can include a spectrum sensing system in communication with at least one of the CRNSP module, the CRAVENET, and/or the vehicles for sensing a quality of a particular spectrum and/or channel thereof. The system can include a spectrum analysis module in communication with the spectrum sensing system and configured to determine which spectrum and/or channel thereof are available for use and/or meet a quality of service (QoS) need of the CRAVENET.

The CRNSP module can include one or more routines configured to receive input data from one or more of the vehicles, users, or nodes in the CRAVENET and to process the data and to produce output data for the vehicles and/or users. The one or more routines can include machine learning.

The one or more routines can include a traffic routing management system configured to provide a platform to receive input data of traffic information and produce output data of routing the traffic as a function of the traffic information using CRAVENET. The one or more routines can include an optimization routine to route the traffic dynamically through different exits from freeways to reduce congestion. The optimization routine can use set of destinations of vehicles as input.

The CRNSP module can be configured to perform real time data collection and uploading to the cloud of driving related data for use by vehicles in the CRAVENET. The driving related data can include one or more of traffic, driving behavior, road conditions, weather conditions, or local constructions sites, for example. Any other suitable data is contemplated herein.

In certain embodiments, the one or more routines can include a multi-hop remote area coverage routine configured to enhance telecommunication coverage area using one or more vehicles in the CRAVENET as range extending nodes in the CRAVENET. The multi-hop remote area coverage system routine can include tagging locations of cellular service blind spots and/or dead zones and sharing said locations with other users and/or vehicles in the CRAVENET. The one or more routines can include a relative positioning and tracking system routine configured to track one or more vehicles using direct or multi-hop methodology.

In certain embodiments, the one or more routines include a real-time three dimensional GPS tracking, storage, and sharing routine configured to provide at least one of other than traditional GPS, a real-time three-dimensional map, live streaming of street views, intersection views, and/or an adaptive optimized route to avoid traffic congestion or delays. Any other suitable data or routes are contemplated herein.

The one or more routines can include a bandwidth resource sharing routine configured to cause vehicles in the CRAVENET to share bandwidth resources as available in within the CRAVENET. The bandwidth resource sharing routine can be configured to distribute data among vehicles and/or nodes within the CRAVENET such that each vehicle and/or node can upload and/or download in packets or data chunks.

In accordance with at least one aspect of this disclosure, a method for efficiently utilizing wireless communications spectrum includes allocating a spectrum or one or more channels thereof to a primary user, determining when an available time period when the spectrum or the one or more channels thereof are available for use, and leasing and reallocating the available spectrum or the one or more channels to a secondary user of (CRAVENET for at least a portion of the available time period. The method can include offering a reward to the primary user for making the spectrum and/or one or more channels available.

In accordance with at least one aspect of this disclosure, a non-transitory computer-readable medium stores instructions which, when executed by one or more processors, cause a system to perform a method for efficiently utilizing wireless communications spectrum. The method for efficiently utilizing wireless communications spectrum includes allocating a spectrum or one or more channels thereof to a primary user, determining when an available time period when the spectrum or the one or more channels thereof are available for use, and leasing and reallocating the available spectrum or the one or more channels to a secondary user of a cognitive radio ad hoc vehicular network (CRAVENET) for at least a portion of the available time period. The method can also include offering a reward to the primary user for making the spectrum and/or one or more channels available.

In accordance with at least one aspect of this disclosure, a vehicle includes a cognitive radio ad hoc vehicular network (CRAVENET) module configured to receive data from one or more vehicles, nodes, and/or hosts of a cognitive radio ad hoc vehicular network (CRAVENET). The CRAVENET can be hosted by at least one cognitive radio network service provider (CRNSP) module. The CRAVENET module can be configured to send data to the one or more vehicles, nodes, and/or hosts CRAVENET. These and other aspects of the present disclosure will become apparent from following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment.

FIG. 1 schematically shows a cognition cycle for an embodiment of a CR system in accordance with this disclosure.

FIG. 2 shows an embodiment of a Dynamic Spectrum Leasing Model (DSLM) in accordance with this disclosure.

FIG. 3 is a flow diagram of the subtasks of each phase of the six-phased architecture and model of a cognition cycle.

FIG. 4 shows an embodiment of CRAVENET architecture in accordance with this disclosure.

FIG. 5 shows a schematic of functional blocks or generators of an embodiment of the CRAVENET.

FIG. 6 shows a schematic diagram of an embodiment of a system in accordance with this disclosure.

FIG. 7 shows a schematic diagram of an embodiment of a plurality of vehicles in a cognitive network in accordance with this disclosure.

FIG. 8 shows a flow diagram of an embodiment of a method in accordance with this disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The terms “routine” and “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure in one aspect relates to vehicular hybrid network systems. One of ordinary skill in the art would appreciate that, unless otherwise indicated, certain computer systems and/or components thereof may be implemented in, but not limited to, the forms of software, firmware or hardware components, or a combination thereof.

The apparatuses, systems, and/or methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

In accordance with the purposes of present disclosure, as embodied and broadly described herein, in certain aspects, the present disclosure relates to networking systems (e.g., cognitive radio networks), more particularly to smart vehicular hybrid network systems and methods (e.g., for local business marketing, traveler safety, and vehicular emission control). Disclosed herein, in at least some embodiments, are methods, systems, and apparatuses for dynamic spectrum leasing methodology (DSLM), a paradigm which can be based on game theoretic concepts. DSLM takes into account the demand for spectrum by secondary users and the willingness of primary users to relinquish spectrum in a restricted manner, making possible spectrum leasing as a long-term commercially viable concept. Embodiments include a Cognitive Radio Network Service Provider (CRNSP) and the leasing of spectrum by the CRNSP from a Wireless Service Provider (WSP), for example.

By defining suitable utility functions, a game theoretic formulation is disclosed allowing the CRNSP to lease the licensed spectrum bands from the WSP. Also disclosed are embodiments of cognitive radio ad-hoc vehicular networks (CRAVENET) and embodiments of their architecture along with applications, security requirements, and challenges that arise in architecting such networks. A hybrid system which comprises CRAVENET and wireless data network (WDN) is disclosed. While CRAVENET is described for use in inter vehicular communication, e.g., in backend sharing the local area information which can include local businesses, geo information, traffic information etc., any suitable application is contemplated herein. CRAVENET can use free available spectrum which makes it cost effective technology for such purposes. In certain embodiments, the WDN can be used, e.g., in the scenario when CRAVENET runs out of coverage and also for synchronization of certain vehicular performance data to a web database.

Since autonomous vehicles have been the center of attention to exploit the new dimensions in auto industry, several smart vehicles have been introduced by different manufacturers. Some potential applications using existing technologies to introduce intelligence in an autonomous vehicle are disclosed herein. Embodiments herein are not limited to autonomous vehicles only.

The next generation vehicles are being designed and under research, several experiments have been conducted to put as much intelligence in a vehicle to make them autonomous. The autonomous vehicles are equipped with several sensors to detect the surroundings to avoid accidents and to follow the given path. A vehicle's performance is always a concern whether it is autonomous or driver dependent. The users are also concerned about the surroundings they are passing through. Embodiments can interconnect the local businesses over a cognitive radio network (CRN) and can also upload the vehicular performance data over a web database through CRN or wireless data network.

Moreover, our world has been facing the threat of global warming due to tremendous increase in atmospheric pollution. A major component of atmospheric pollution is the vehicular emissions. According to Union of Concerned Scientists USA (UCSUSA), “Our personal vehicles are a major cause of global warming. Collectively, cars and trucks account for nearly one-fifth of all US emissions, emitting around 24 pounds of carbon dioxide and other global-warming gases for every gallon of gas. About five pounds comes from the extraction, production, and delivery of the fuel, while the great bulk of heat-trapping emissions—more than 19 pounds per gallon—comes right out of a car's tailpipe.” Solutions include the use of clearer fuel, cutting down the fuel (e.g., gasoline and diesel etc.) usage and electric vehicles. Embodiments include a regulatory solution to control malfunctioned vehicles emissions.

Certain existing systems allow an emergency call in case of car accident and the driver/passenger is not able to make the emergency call. This is limited to the emergency procedures only based on the values of accelerometer, gyroscope and magnetometer. This service is provided by Mercedes to its customers who pay for the service. Certain vehicles allow paid-for online customer service with some of the automated features from remote locations to control the car (e.g., to unlock the car). Certain applications were developed for smart phones to record the bumps on the roads/streets according to their location to report the road conditions to authority for fixation. Certain applications (e.g., Drivewise) is used by insurance companies to monitor the driver's driving patterns.

Emissions Detection and Reporting (EDAR) is a latest technology which is based on an optical camera to detect the levels of different components of vehicular emissions. It is mounted on poles by the road and it is limited to just detect the vehicle only once. This approach does not have the feature to record the emission of a vehicle over the time period, for example. Embodiments can utilize one or more of the above systems, and/or any other suitable systems, for example, as appreciated by those having ordinary skill in the art in view of this disclosure.

Spurred on by rapid advances in wireless communications and networking, sophisticated applications, including social applications, have emerged that have revolutionized people's life by providing convenient and flexible access to information, products, services, and people. Consequently, the demand for spectrum has grown drastically. Principally designed to improve spectrum utilization, it is anticipated that cognitive radio technology will find wide applicability in a number of diverse fields. Embodiments as disclosed herein apply CR to the field of vehicular ad-hoc networking and fuel the evolution of communication networks and social applications.

A Cognitive Radio ad-hoc Vehicular Network (CRAVENET) is a mobile network with vehicles equipped with CR devices to facilitate the vehicles to communicate with each other and with fixed CR devices. In other words, CRAVENET facilitates communication between mobile and fixed CR devices (e.g., referred to as nodes herein). It may provide a promising approach to facilitate traffic management and road safety management. One of the requirements of this network may be to ensure secure communication between participants, safeguard private information, and facilitate high volume data exchange. With a suitable multi-applications suite, embodiments of CRAVENET allow an intelligent transportation system requiring no special purpose routers. Moreover, the network can be dynamic with mobile vehicular CR devices along with, possibly, fixed CR devices forming the nodes of the network and capable of reorganizing when existing nodes leave and new nodes join.

Each CR enabled vehicle in CRAVENET is free to move independently in any allowed direction, and may therefore change its connectivity to other devices frequently. While some vehicle manufacturers and telecommunication companies have been taking advantage of the available technology in the vehicles and existing cellular infrastructure to enable vehicular users to communicate with each other, by exploiting CR technology, CRAVENET can continue to provide connectivity among vehicles even when cellular connectivity is sparse, poor, or unavailable and, consequently, will improve the user experience and make driving safer. In certain embodiments, as a social networking facilitator, CRAVENET can enable vehicle occupants to broadcast their interests and receive information such as road hazards, accidents along their chosen route, nearby restaurants, grocery stores, shopping places, gas stations, tourist attractions, upcoming traffic jam related messages, speed limit related messages and local events.

Emergency messages may also be generated and broadcast among the participants. In the area of security and privacy in communication, there may be many requirements to meet and challenges to overcome. Security concerns range from malicious behavior of users to denial of service attacks to guarding user's privacy. Mobility of vehicles and the dynamic nature of nodes in CRAVENET may bring about additional challenges in ensuring security and privacy. The individual vehicle data including the user name, license id, speed, current position, source address, destination address, traveled routes and other related information may be secured and protected in any suitable manner.

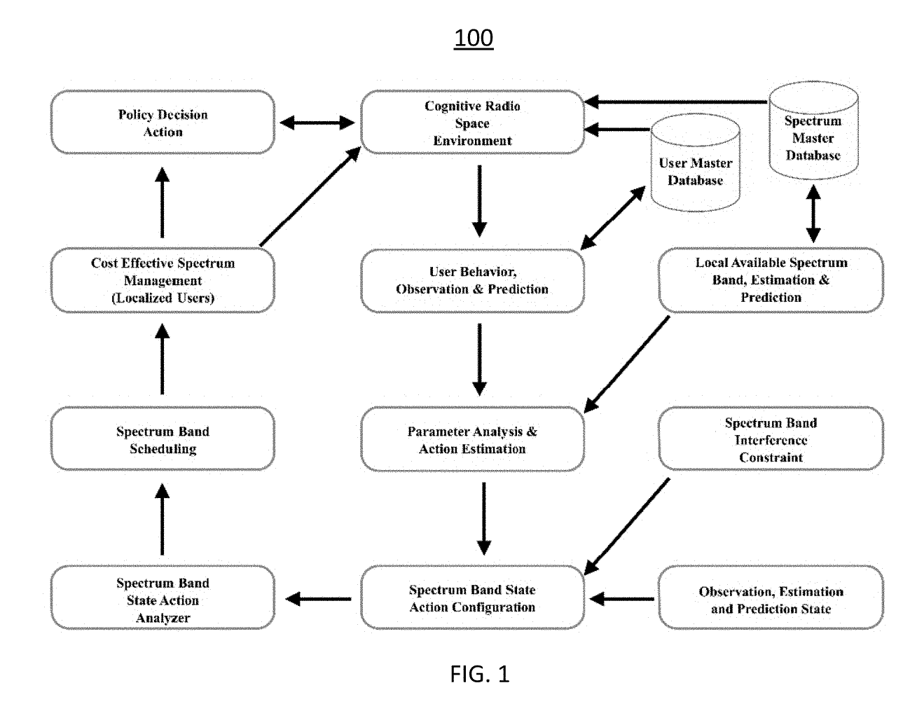

FIG. 1 shows a cognition cycle 100 for an embodiment of a CR system in accordance with this disclosure. As shown, FIG. 1 illustrates an enhanced cognition cycle 100 for the CR system that takes into account, in addition to the cognitive radio environment and spectrum availability as provided by the Spectrum Master Database, the behavior of users concerning spectrum usage, and their observation regarding spectrum sensing and estimation of the quality of channels and other measurements they may make and wish to share, which are then made available in a User. Master database consists of user's behavior that impacts the cognition cycle may be different at different phases. For example, user behavior may refer to their willingness to forget/not care about spectrum usage during certain hours of the day. The user of a wireless service provider and/or the WSP may then collect such information and lease out spectrum to a cognitive radio network service provider for use by CR users as will be further explained later. From the data collected, using machine learning, for example, useful data can be extracted that will help in the allocation of spectrum bands to users taking into account their requirements, for example, QoS needs, so as to optimize spectrum utilization.

Since embodiments strike a synergy between traditional CR approaches and machine learning, and take into account in models of user behavior and requirements, one or more of following can be rules applied to the use of leased spectrum. (1) While allocating channels to CR users, ensure adequate QoS is provisioned so as to meet their expected or specified requirements. (2) Ensure traffic management so as to avoid saturation of spectrum. (3) Apply reinforcement learning techniques by defining suitable states of users (based on their behavior of spectrum of spectrum usage) and reward functions to users based on their actions to optimize channel sensing, channel allocation, and/or channel utilization, which essentially form the tasks of spectrum management. (4) Invoke deep learning techniques to help understand the user's behavior and ensure that channels are allocated to users so as to meet the users QoS needs real time in an adaptive manner.

Embodiments and/or any suitable portions thereof of the cognitive cycle 100 shown in FIG. 1 can be implemented using any suitable computer hardware and/or software as appreciated by those having ordinary skill in the art.

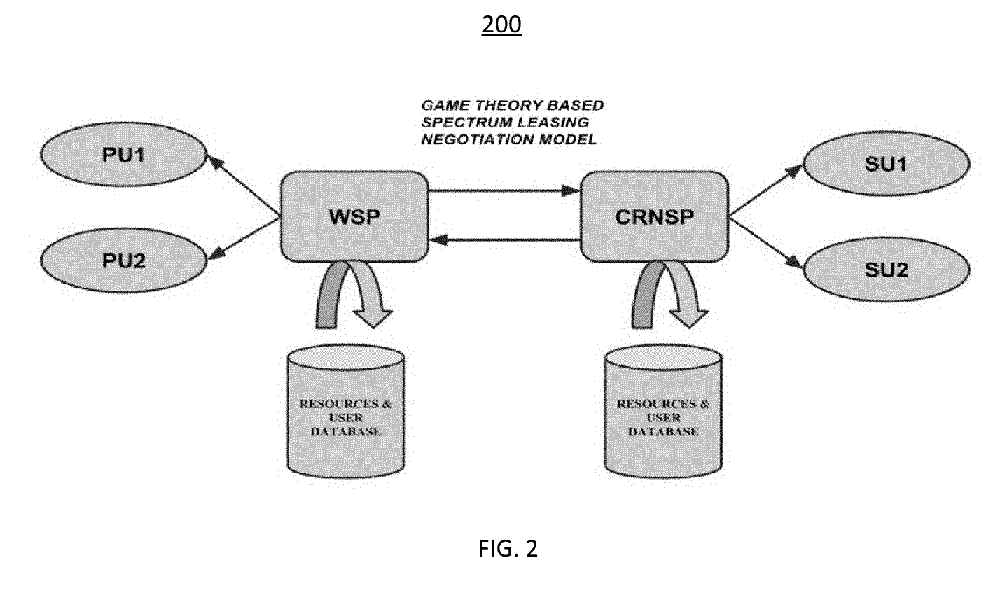

FIG. 2 shows an embodiment of a Dynamic Spectrum Leasing Model (DSLM) 200 in accordance with this disclosure. A traditional wireless service provider (WSP) and a cognitive radio network service provider (CRNSP) can interact, e.g., using a cooperative game playing and learning strategy to share spectrum.

In FIG. 2, PU denotes a primary user of a WSP and SU denotes a secondary user of CRNSP. FIG. 2 depicts the interaction between a WSP and a CRNSP that will facilitate leasing spectrum by the CRNSP from the WSP. In certain embodiments, the PUs may choose to give up their use of the licensed spectrum, e.g., during certain hours, and may inform their WSP accordingly (e.g., with a suitable application, message, or in any suitable manner). In turn, the WSP can reward their users for their actions. The WSP can dynamically update the spectrum bands that are available and lease the available spectrum to CRNSP. In certain embodiments, the WSP and the CRNSP can interact with each other in any suitable manner (e.g., via a data connection) to dynamically lease the spectrum (e.g., by providing the CRNSP with a dynamically updated list of usable spectrum and/or channels thereof for a licensing fee). Also, a layer of security can be introduced between the PUs and SUs in any suitable manner.

The four sets of users as shown in the embodiment of FIG. 2 are defined as follows. The Primary User I (PU1) is the user that does not opt for the reward program of the WSP. The Primary User II (PU2) is the user who is willing to opt for the reward program of the WSP and relinquish the use of spectrum during non-busy hours to the WSP. The Secondary User I (SU1) is the user who subscribes to the CR services offered by CRNSP. The Secondary User II (SU2) is the user who is a default user and has not subscribed to any services from CRNSP, but can utilize the services as needed.

Such a model 200 lends itself to game-theoretic analysis. Any suitable application of game theory to the DSLM 200 of FIG. 2 is contemplated herein. In certain embodiments, a cooperative game theory approach can be followed by the WSP and the CRNSP. Using this approach, both service providers can work together on a leasing agreement to raise their revenue and fulfill their user requirements. For example, the WSP can share the information of the unused available spectrum bands of the licensed users with CRNSP. By sharing this information with CRNSP, WSP can increase its revenue by receiving a fee from CRNSP in return. Using this shared information CRNSP can satisfy their users' requirements for connectivity and quality of service (QoS).

In certain embodiments, a non-cooperative game theory approach can be followed by the WSP and the CRNSP to satisfy their users' requirement independently of each other. As described above, the WSP users as shown in the DSLM 200 of FIG. 2, are categorized into two types: PU1 and PU2. PU1 is not interested in enrolling in the reward program while PU2 enrolls in the reward program offered by the WSP to reduce the cost of subscribing to services from WSP.

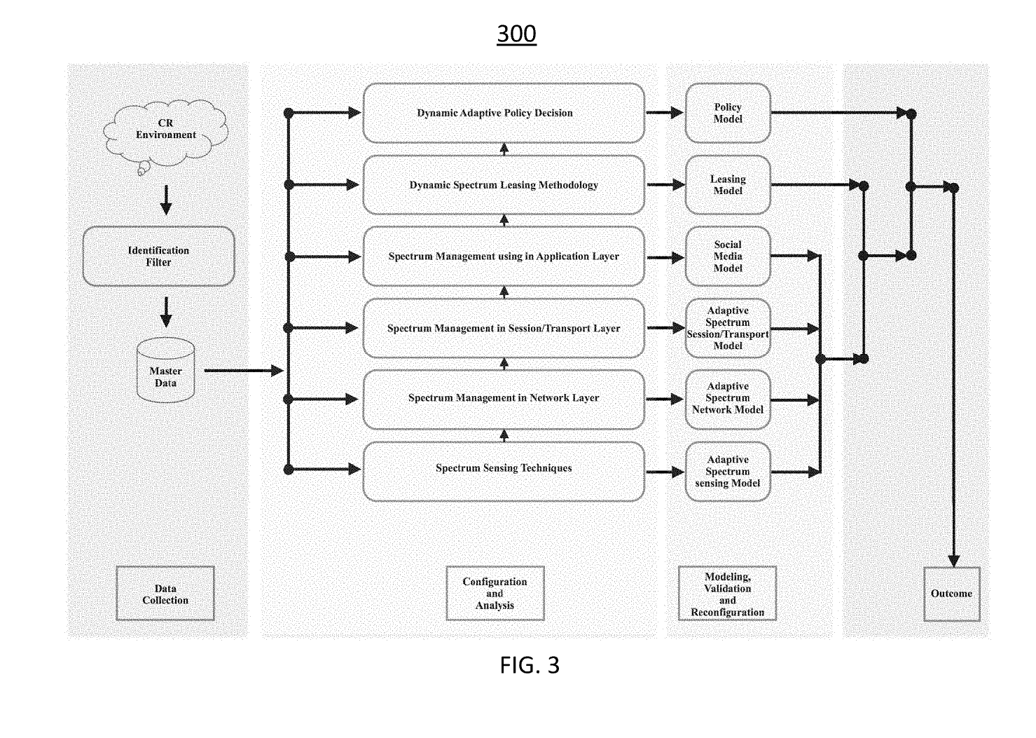

In a six phase cognition cycle model, described more below, each phase includes the subtasks of (1) data collection, (2) configuring the data and formulating or choosing techniques applicable at each phase for the analysis of collected data, (3) formulating, validating, and improving the cognition cycle models, and (4) formulating the final model as output of each phase. FIG. 3 is a flow diagram of the subtasks of each phase of the six-phased architecture and model of a cognition cycle. A description of each of the six phases is below.

A phase of the six phases can be spectrum sensing and channel estimation techniques. The spectrum sensing and channel estimation techniques phase involves literature survey and implementing many of the techniques including those developed by the authors. In this case, the input includes channel sensing and estimation algorithms and user's behavior regarding usage of channels and the output includes formulation and analysis of a cognitive cycle model that incorporates and adapts sensing and estimation strategies so as to minimize battery power consumption while meeting user requirements.

A phase of the six phases can be spectrum management at the network layer. In the spectrum management at the network layer phase, an ad hoc vehicular network scenario is considered for purposed of illustration. Data is collected about the behavior of users in an ad hoc vehicular network setting concerning the use of the spectrum, their requirements, and spectrum availability in a dynamic manner. Available channels are matched and allocated to the users dynamically. Machine learning (e.g., deep learning and reinforced learning), techniques can be applied to the process of spectrum management to maximize efficient spectrum utilization. Inputs include users' behavior regarding usage of channels and outputs include a cognition cycle model at the network layer, new algorithms, and their analyses, and new contributions to the fields of cognitive radio networking and machine learning.

A phase of the six phases can be spectrum management at the session layer. At the spectrum management at the session layer phase, the issues that are of concern include maintaining an ongoing session between two vehicular users, independent of their relative speeds. Techniques from machine learning can be applied to determine channel resources for the session and ensure that backup channels are available should the currently used channels for the session do not meet the user needs due to low signal quality due to, for example, channel noise, interference, or shadowing. Inputs can include users' behavior regarding usage of channels and outputs include a cognition cycle model at the session layer, new algorithms and their analyses, and new contributions to the field of cognitive radio networking and machine learning.

A phase of the six phases can be spectrum management using machine learning at the application layer. At the spectrum management using machine learning at the application layer phase, in the context of an ad hoc vehicular network and V2V (Vehicle to Vehicle) scenario, this phase of the work involves collection of blog data involving traffic conditions or other items of interest to passengers involved, and formulation of a cognition cycle at the application layer. Inputs can include social user behavior, user requirements, and blog data and outputs can include a cognition cycle model at the application layer and formulation, analysis, validation, and improvement of novel spectrum sharing and assignment algorithms for the ad hoc vehicular networking V2V scenario.

A phase of the six phases can be dynamic spectrum leasing methodology. At the dynamic spectrum leasing methodology phase, The CRNSP can lease spectrum. It is assumed that, while a CRNSP may not have an assigned spectrum, the CRNSP is able to lease spectrum from a WSP. The WSP is in turn able to determine the users' behavior regarding spectrum usage and is able to determine what spectrum can be leased out to the CRNSP on a dynamic basis. Inputs include the WSP users' behavior regarding spectrum usage and outputs include a dynamic spectrum leasing algorithm that facilitates efficient spectrum sharing between the WSP and CRNSP.

A phase of the six phases can be dynamic adaptive policy decision making. At the dynamic adaptive policy decision making phase, the WSP can formulate policies for bandwidth allocation and resources needed to ensure QoS so as to maximize user satisfaction with respect to the service needs. Inputs can include users' behavior regarding spectrum usage and outputs can include an adaptive policy model.

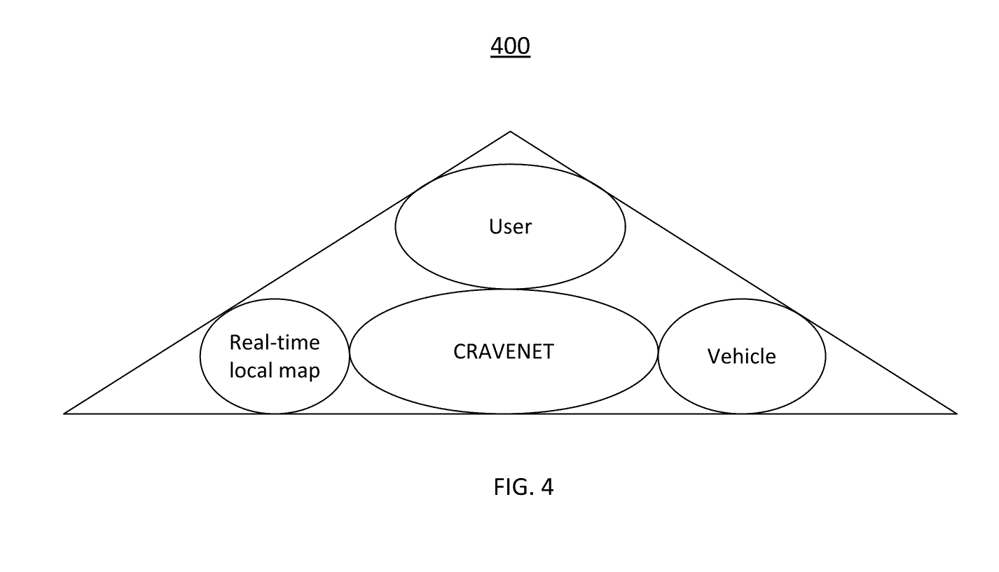

FIG. 4 shows an embodiment of CRAVENET architecture 400 in accordance with this disclosure. As appreciated by those having ordinary skill in the art, it is contemplated that the CRAVENET architecture 400 and/or any suitable portion thereof can be embodied as any suitable hardware and/or software modules. In certain embodiments, CRAVENET architecture can include spectrum management, traffic management, vehicle properties (e.g., acceleration and braking), individual vehicle mobility patterns, and spectrum band demand patterns. Any other suitable properties are contemplated herein. As shown, the CRAVENET architecture 400 includes one or more of the following characteristics: (1) a real-time local map characteristic which can include intersections, street views, speed limits, multiple lanes, new constructed lanes, new developed attraction points, new stores, new business buildings, and new traffic laws at particular locations, for example. (2) User characteristic which can include a driver's vehicle driving patterns, their real time decision patterns on controlling the vehicle at different situations like at an obstacle, red light, stop sign, yield sign and traffic jam, for example. (3) Vehicle characteristic which can include vehicle motion properties on streets and highways, trip maps including source and destination details with their interests, accelerations and deceleration behavior of the vehicle, for example.

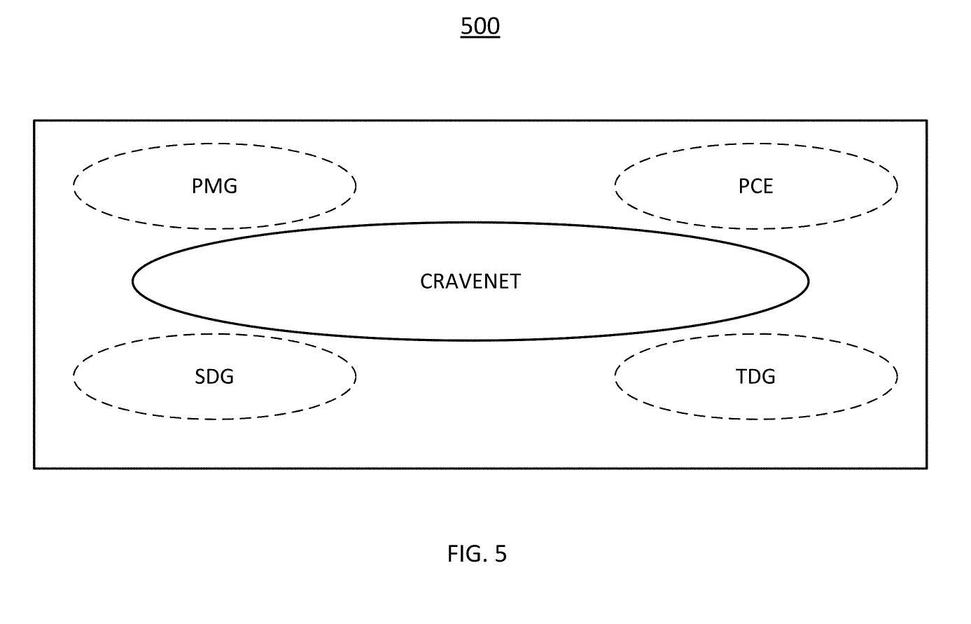

FIG. 5 shows a schematic 500 of functional blocks or generators of an embodiment of the CRAVENET. CRAVENET architecture can include a Path Map Generator (PMG), a Path Cost Estimator (PCE), a Spectrum Demand Generator (SDG), and a Traffic Demand Generator (TDG) as functional blocks/generators. The PMG observes the user interest and generates the source to destination map accordingly. It includes the constraints like temporary road works, new constructions, real time traffic status, speed limits, stop signs and yield signs. The PCE observes the source to destination pathway and includes the gas cost, traffic conditions, weather conditions, and road conditions for example. Any suitable conditions are contemplated herein.

The SDG observes the real time demand for spectrum bands by the individual user at a particular location. It may alter the computation technique to detect the requirement of spectrum bands based on the user behavior. The TDG observes the density of vehicles at peak hours and non-peak hours. It estimates the upcoming traffic based on previous experiences. It detects the motion of vehicle and estimates their traffic flows. It may alter the path, if required based on the user interest.

Each of block/generator can be implemented in any suitable manner such as any suitable computer hardware and/or software (e.g., suitable code/routines) as appreciated by those having ordinary skill in the art.

CRAVENET applications can take into account user safety, comfort, and local resources. For example, a comfort based application can provide traffic congestion alerts, inclement weather alerts, next toll alerts, parking availability alerts, no-parking zone alerts, gas station alerts and rest area alerts. A local resources based application can provide users with interest based notifications about restaurants, parks, attractions, historical places, zoos, shopping malls, designer stores, service centers, grocery stores, theaters, fitness centers, book stores, gaming centers, body care centers, and hospitals. A safety based application can provide road monitoring services in real time, Pre-Collision Notifications (PCN), Emergency Notifications (EN), Traffic Aware Notifications (TAN) and Road Hazard Notifications (RHN). Any suitable applications are contemplated herein and can be presented to the user via any suitable interface (e.g., via a display mounted in the vehicle, via a suitable mobile device).

Embodiments can include a Traffic RoutIng Management System (TRIMS). The inter vehicle communication can provide a platform to share the traffic information with each other to route the traffic accordingly using CRAVENET. An optimization algorithm can route the traffic dynamically through different exits from freeways to reduce the congestion. The destinations of cars can be shared anonymously and can be used as input to the algorithm.

In certain embodiments, the CRAVENET technology can also be used for real time data collection and uploading on cloud such as traffic, driving behavior, road conditions, weather conditions and local constructions sites etc. Any suitable data is contemplated herein.

Embodiments can include a multi-hop remote area coverage system. Telecommunication coverage area can be enhanced using multi-hop methodology using CRAVENET. It can fill the service coverage gaps on the highways and in remote areas if enough number of vehicles are connecting through CRAVENET. It can also be used to tag the cellular service blind spots and dead zones, which can further be shared among CRAVENET.

Embodiments can include a relative positioning and tracking system. The CRAVENET can be used to track a certain vehicle using direct or multi-hop methodology on a highway, such as to keep the track of a convoy. Embodiment can include a real-time three dimensional GPS tracking, storage and sharing. For example, the CRAVENET can be used for traffic management analysis in a real-time GPS tracking and sharing application. This application may provide other than traditional GPS, the real-time three-dimensional map, live streaming of street views, intersection views with an adaptive optimize route to avoid traffic congestion or delays due to accident or construction sites. This allows each vehicle to store the necessary map data and share their trip maps with friends and family members, insurance partners and auto expert engineers on social networking sites.

Embodiments can include a bandwidth resource sharing system. This application provides accessing vehicles to share their bandwidth resources as per their requirement in CRAVENET. It is difficult to upload/download large volume files and access multimedia applications due to high speed vehicles and limited wireless bandwidth. If there is large data to be uploaded, the data can be distributed among CRAVENET and each node can upload in chunks, and download in similar manner. Certain security aspects are required to implement such distributive network.

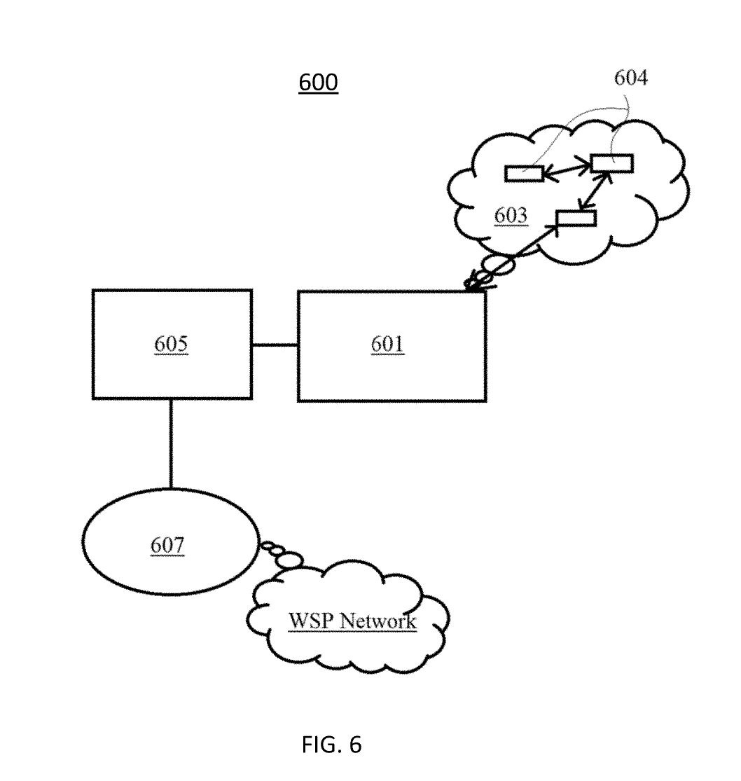

In view of this disclosure, in accordance with at least one aspect of this disclosure, referring to FIG. 6, a vehicular hybrid network system 600 can include a cognitive radio network service provider (CRNSP) module 601 (e.g., a server or other suitable computer hardware/software system) configured to host a cognitive radio ad hoc vehicular network (CRAVENET) 603 and to provide information services to a plurality of vehicles 604 in the CRAVENET. The system 600 also includes a spectrum leasing module in communication with the network service provider module, the spectrum leasing module 605 configured to communicate with a wireless service provider (WSP) 607 to lease spectrum from the WSP 607 for use by the plurality of vehicles 604 in the CRAVENET 603.

The system 100 can include a spectrum sensing system in communication with at least one of the CRNSP module 601, the CRAVENET 603, and/or the vehicles for sensing a quality of a particular spectrum and/or channel thereof. The system 100 can include a spectrum analysis module in communication with the spectrum sensing system and configured to determine which spectrum and/or channel thereof are available for use and/or meet a quality of service (QoS) need of the CRAVENET 603.

The CRNSP module 601 can include one or more routines (e.g., suitable computer code) configured to receive input data from one or more of the vehicles, users, or nodes in the CRAVENET 603 and to process the data and to produce output data for the vehicles and/or users. The one or more routines can include machine learning as appreciated by those having ordinary skill in the art.

The one or more routines can include a traffic routing management system configured to provide a platform to receive input data of traffic information and produce output data of routing the traffic as a function of the traffic information using CRAVENET 603. The one or more routines can include an optimization routine to route the traffic dynamically through different exits from freeways to reduce congestion. The optimization routine can use a destination of a vehicle as an input.

In certain embodiments, the CRNSP module 601 can be configured to perform real time data collection and uploading to the cloud of driving related data for use by vehicles in the CRAVENET 603. The driving related data can include one or more of traffic, driving behavior, road conditions, weather conditions, or local constructions sites, for example. Any other suitable data is contemplated herein.

In certain embodiments, the one or more routines can include a multi-hop remote area coverage routine configured to enhance telecommunication coverage area using one or more vehicles in the CRAVENET 603 as range extending nodes in the CRAVENET 603. The multi-hop remote area coverage system routine can include tagging locations of cellular service blind spots and/or dead zones and sharing said locations with other users and/or vehicles in the CRAVENET 603. The one or more routines can include a relative positioning and tracking system routine configured to track one or more vehicles using direct or multi-hop methodology.

In certain embodiments, the one or more routines include a real-time three dimensional GPS tracking, storage, and sharing routine configured to provide at least one of other than traditional GPS, a real-time three-dimensional map, live streaming of street views, intersection views, and/or an adaptive optimized route to avoid traffic congestion or delays. Any other suitable data or routes are contemplated herein.

The one or more routines can include a bandwidth resource sharing routine configured to cause vehicles in the CRAVENET 603 to share bandwidth resources as available in within the CRAVENET 603. The bandwidth resource sharing routine can be configured to distribute data among vehicles and/or nodes within the CRAVENET 603 such that each vehicle and/or node (e.g., fixed CR devices) can upload and/or download in packets or data chunks.

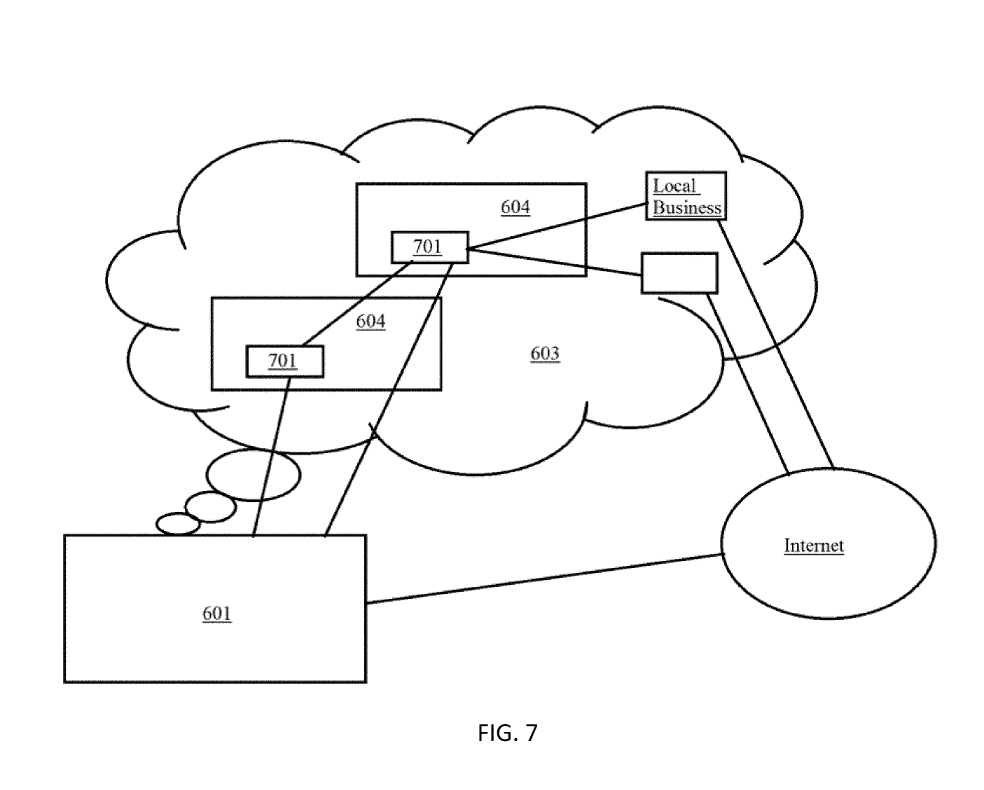

In accordance with at least one aspect of this disclosure, referring additionally to FIG. 7, a vehicle 604 includes a cognitive radio ad hoc vehicular network (CRAVENET) module 701 configured to receive data from one or more vehicles 604, nodes, and/or hosts (e.g., CRNSP module 601) of a cognitive radio ad hoc vehicular network (e.g., CRAVENET 603). The CRAVENET module 701 can be configured to send data to the one or more vehicles, nodes, and/or hosts of the CRAVENET 603.

The CRAVENET 603 can be hosted by at least one cognitive radio network service provider (CRNSP) modules 601 or any other suitable module. The CRNSP module 601 can itself be any suitable number of components, and/or can be hosted in the cloud and/or in dynamic locations.

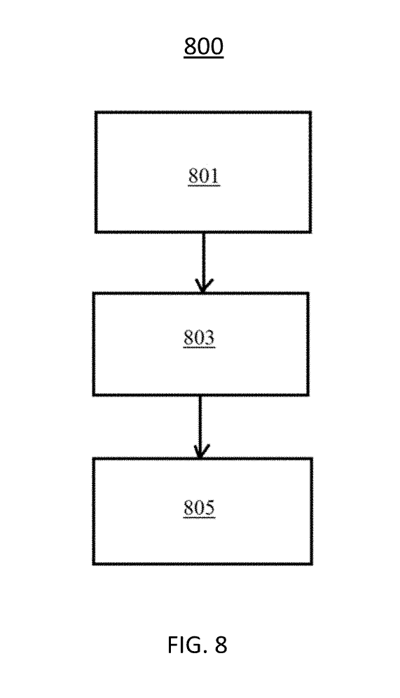

In accordance with at least one aspect of this disclosure, referring to FIG. 8, a method 800 for efficiently utilizing wireless communications spectrum includes allocating (e.g., at block 801) a spectrum or one or more channels thereof to a primary user, determining (e.g., at block 803) when an available time period when the spectrum or the one or more channels thereof are available for use, and leasing and reallocating (e.g., at block 805) the available spectrum or the one or more channels to a secondary user of a cognitive radio ad hoc vehicular network (CRAVENET) for at least a portion of the available time period. The method 800 can include offering a reward to the primary user for making the spectrum and/or one or more channels available.

Embodiments as described herein can be used for vehicle emission statistics, e.g., for administrative purposes. Every year, vehicles undergo a smog test in most of the states in USA and in several other countries. This test is conducted only once a year which prevents very less amount of smog due to vehicles for the rest of the year. For example, if a vehicle has contributed much pollution during the entire year and just before the smog test, it was fixed to pass the test. It is a moral responsibility of everyone to ensure the smog performance of their vehicles and not just for the test. Each vehicle can be equipped with a device that can detect and record the amount and intensity of emissions of vehicle. There are cars in the market with smog sensors, but there is no mechanism to do the statistical analysis of smog based on the entire year's car performance. The CRAVENET can be used to perform a statistical analysis on emissions and/or send such data to the Department of Motor Vehicles for further action or sending the notices to vehicle owners over the year.

Embodiments can be used for vehicle performance and emergency procedures interconnect. This feature can enable a smart interconnect between four entities, vehicle, auto shops, auto insurance agency and emergency services. The available solutions provide emergency services along with car performance monitoring services on the go. These services are only provided at a high cost through customer support center around 24/7. There is no automated system available which monitors vehicle performance and activity at the same time, and also computes the optimal solutions that can be undertaken in a nearby service facility. If the vehicle malfunctions, the idea is to find an auto specialist available at a nearby location and find the optimal options to repair according to auto insurance coverage. In many countries, auto insurance agencies only provide the auto services from specific auto specialists. Also, the insurance coverage will be computed accordingly to suggest possible options to the user. In case of emergency, the emergency procedure such as 911 services can be offered.

Embodiments can be used to promote and share local area information on the go. Every year small business merchants spend thousands of dollars for marketing. Start-up business merchants spend about 20-30% of their annual budget for advertisement of their product. Existing ways of advertisement include print ads, radio, television commercials, direct mail campaigns, telephone book ads, attendance at trade shows, website and social media. There is no such automated marketing system available that provide affordable and easy marketing for new merchandise to the people passing through their businesses. Embodiments enable a smart connection between a merchant and vehicle driver or passengers. A merchant can negotiate the price of merchandise with the buyers in real time. This feature offers a low cost and affordable advertisement to the small business owners or even large businesses as well.

Embodiments can act as a driver assistant. According to Association for Safe International Road Travel (ASIRT), over 37,000 people die in road crashes each year in United States. Road crashes cost the United States $230.6 billion per year. Improper turns, tail gating, potholes, tire blowouts, curvy roads and construction sites are some causes of accidents or injuries. This feature can reduce the accidents by providing the real time street views, foregoing vehicle experiences and behaviors, upcoming or ongoing construction updates, road conditions, weather conditions and traffic conditions in the nearby locations.

The only alternative of this technology is by using paid wireless networks. There are products and services available at high cost which are either manual or semi-auto. Some alternatives have been mentioned in the existing technologies section but none of them provide all solutions on one platform using CR network.

Embodiments include automation of the nearby local business information within a specific radius as a vehicle enters, which has not been introduced before in the art. This feature is better than just looking up on search engines, instead the local businesses will be able to interconnect with all the vehicles in that radius broadcasting their promotions, deals, products and it will be just a matter of one click by the user to select.

The CR provides an inexpensive way to promote small businesses especially for the traveler passing through a particular area. Embodiments can also be used by road construction companies and broadcast the construction sites information to incoming traffic, instead of using high powered road side warning indicators.

Vehicles using fossil fuels emit tremendous amounts of components to pollute the environment. It certainly cannot be eliminated unless a different form of fuel/energy is used to run the vehicles. However, embodiments include a way to reduce the significant amount of malfunctioning vehicles emissions.

It is appreciated by those having ordinary skill in the art that any suitable method, system, and/or apparatus may be embodied in any suitable computer hardware and/or software as appreciated by those having ordinary skill in the art. The functions of each embodiment and component thereof (e.g., how data is input, transmitted, received, processed, output, etc.) for each embodiment of a system, method, and apparatus is appreciated by those having ordinary skill in the art in view of the disclosure and the described functions of each portion of the embodiments, and one having ordinary skill in the art appreciates that such portions of this disclosure are enabling.

It should be noted that all or a part of the steps according to the embodiments of the present disclosure is implemented by hardware or a program instructing relevant hardware. Yet another aspect of the invention provides a non-transitory computer readable storage medium which stores computer executable instructions or program codes. The computer executable instructions or program codes enable a computer or a similar computing apparatus to complete various operations in the above disclosed method for efficiently utilizing wireless communications spectrum. The storage medium includes, but not limited to, a magnetic disk, an optical disk, a read-only memory (ROM), a random access memory (RAM), flash dive, or the likes.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

While there has been shown several and alternate embodiments of the present invention, it is to be understood that certain changes can be made as would be known to one skilled in the art without departing from the underlying scope of the invention as is discussed and set forth above and below including claims and drawings. Furthermore, the embodiments described above and claims set forth below are only intended to illustrate the principles of the present invention and are not intended to limit the scope of the invention to the disclosed elements.

References, which may include patents, patent applications and various publications, may be cited and discussed in this disclosure. The citation and/or discussion of such references is provided merely to clarify the description of the present invention and is not an admission that any such reference is “prior art” to the invention described herein. All references cited and discussed in this disclosure, are incorporated herein by reference in their entireties and to the same extent as if each reference was individually incorporated by reference.

What is claimed is:

1. A vehicular hybrid network system, comprising:
a cognitive radio network service provider (CRNSP) module configured to host a cognitive radio ad hoc vehicular network (CRAVENET) and to provide information services to a plurality of vehicles in the CRAVENET; and
a spectrum leasing module in communication with the network service provider module, the spectrum leasing module configured to communicate with a wireless service provider (WSP) to lease spectrum from the WSP for use by the plurality of vehicles in the CRAVENET.

2. The system of claim 1, further comprising a spectrum sensing system in communication with at least one of the CRNSP module, the CRAVENET, and/or the vehicles for sensing a quality of a particular spectrum and/or channel thereof.

3. The system of claim 2, further comprising a spectrum analysis module in communication with the spectrum sensing system and configured to determine which spectrum and/or channel thereof are available for use and/or meet a quality of service (QoS) need of the CRAVENET.

4. The system of claim 1, wherein the CRNSP module includes one or more routines configured to receive input data from one or more of the vehicles, users, or nodes in the CRAVENET and to process the data and to produce output data for the vehicles and/or users.

5. The system of claim 4, wherein the one or more routines include machine learning.

6. The system of claim 4, wherein the one or more routines include a traffic routing management system configured to provide a platform to receive input data of traffic information and produce output data of routing the traffic as a function of the traffic information using CRAVENET.

7. The system of claim 6, wherein the one or more routines include an optimization routine to route the traffic dynamically through different exits from freeways to reduce the congestion.

8. The system of claim 7, wherein the optimization routine uses a set of destinations of vehicles as input.

9. The system of claim 4, wherein the CRNSP module is configured to perform real time data collection and uploading to the cloud of driving related data for use by vehicles in the CRAVENET.

10. The system of claim 10, wherein the driving related data includes one or more of traffic, driving behavior, road conditions, weather conditions, or local constructions sites.

11. The system of claim 4, wherein the one or more routines include a multi-hop remote area coverage routine configured to enhance telecommunication coverage area using one or more vehicles in the CRAVENET as range extending nodes in the CRAVENET.

12. The system of claim 11, wherein the multi-hop remote area coverage system routine includes tagging locations of cellular service blind spots and/or dead zones and sharing said locations with other users and/or vehicles in the CRAVENET.

13. The system of claim 4, wherein the one or more routines include a relative positioning and tracking system routine configured to track one or more vehicles using direct or multi-hop methodology.

14. The system of claim 4, wherein the one or more routines include a real-time three dimensional GPS tracking, storage, and sharing routine configured to provide at least one of other than traditional GPS, a real-time three-dimensional map, live streaming of street views, intersection views, and/or an adaptive optimized route to avoid traffic congestion or delays.

15. The system of claim 4, wherein the one or more routines include a bandwidth resource sharing routine configured to cause vehicles in the CRAVENET to share bandwidth resources as available in within the CRAVENET.

16. The system of claim 15, wherein the bandwidth resource sharing routine is configured to distribute data among vehicles and/or nodes within the CRAVENET such that each vehicle and/or node can upload and/or download in packets or data chunks.

17. A method for efficiently utilizing wireless communications spectrum, comprising:
allocating a spectrum or one or more channels thereof to a primary user;
determining when an available time period when the spectrum or the one or more channels thereof are available for use;
leasing and reallocating the available spectrum or the one or more channels to a secondary user of a cognitive radio ad hoc vehicular network (CRAVENET) for at least a portion of the available time period.

18. The method of claim 17, further comprising offering a reward to the primary user for making the spectrum and/or one or more channels available.

19. A non-transitory computer-readable medium storing instructions which, when executed by one or more processors, cause a system to perform a method for efficiently utilizing wireless communications spectrum, the method comprising:
allocating a spectrum or one or more channels thereof to a primary user;
determining when an available time period when the spectrum or the one or more channels thereof are available for use;
leasing and reallocating the available spectrum or the one or more channels to a secondary user of a cognitive radio ad hoc vehicular network (CRAVENET) for at least a portion of the available time period.

20. The non-transitory computer-readable medium of claim 19, wherein the method further comprises offering a reward to the primary user for making the spectrum and/or one or more channels available.

21. A vehicle, comprising:
a cognitive radio ad hoc vehicular network (CRAVENET) module configured to receive data from one or more vehicles, nodes, and/or hosts of a cognitive radio ad hoc vehicular network (CRAVENET),
wherein the CRAVENET is hosted by at least one cognitive radio network service provider (CRNSP) module,
wherein the CRAVENET module is configured to send data to the one or more vehicles, nodes, and/or hosts CRAVENET.

22. The vehicle of claim 21, wherein the CRAVENET module is operatively connected to a display of the vehicle for displaying driving related information to a user of the vehicle.
